(19) United States
(12) Patent Application Publication
(10) Pub. No.: US 2013/0057522 A1
(43) Pub. Date: Mar. 7, 2013

(54) DISPLAY CONTROL APPARATUS, DISPLAY CONTROL METHOD, AND PROGRAM

(71) Applicant: Takeki IKEYA, Kanagawa (JP)

(72) Inventor: Takeki IKEYA, Kanagawa (JP)

(73) Assignee: Sony Corporation, Tokyo (JP)

(21) Appl. No.: 13/571,909

(22) Filed: Aug. 10, 2012

(30) Foreign Application Priority Data
Sep. 5, 2011 (JP) 2011-193027

(51) Int. Cl. G06F 3/038

(52) U.S. Cl. 345/204

(57) ABSTRACT

A display control apparatus includes: a detection block configured to detect a difference between a plurality of pixel data forming image data; and a display control block configured to control switching of said plurality of pixel data based on a detection result.

### BACKGROUND

The present disclosure relates to a display control apparatus, a display control method, and a program.

Recently, as display devices easy to suffer burn-in, display apparatuses having a self light emitting element independently in each pixel are known. For a typical self light emitting display, an organic EL (Electroluminescence) display including organic EL elements is known. In general, the light-emission luminance of an organic EL element is in proportion to the amount of current flowing through the element. It is also known with the organic EL element that, the longer the light-emitting period of the element, or the higher the light-emission luminance of the element, the light-emission efficiency of the element decreases faster. For this reason, for example, if a fixed pattern of high luminance is kept displayed over a long time with a background of low luminance, the luminance in the high-luminance portion decreases faster than that of the low-luminance portion around the high-luminance portion, and the area displaying the fixed pattern is likely to suffer burn-in.

As an example of a disclosure for reducing the chances of burn-in, Japanese Patent Laid-open No. 2005-148558 discloses one in which the display positions of an image displayed on a display are switched at predetermined intervals of time. According to the technology of this reference document, the operation of switching display positions is executed even when the difference between two or more pieces of pixel data displayed in the same pixel is small.

### SUMMARY

However, when the difference between two or more pieces of pixel data that are displayed in the same pixel is small, the condition will not definitely differ from a case where the same image is kept displayed on the same pixel. Thus, burn-in would not be mitigated even if the display positions of pixel data are switched, and instead switching operations may be unnecessarily executed. In addition, since the switching of display positions is carried out constantly at the same interval regardless of the type of image, the power consumption of the switching operation tends to be large.

It is therefore desirable to provide a display control apparatus, a display control method, and a program that can efficiently mitigate burn-in.

One embodiment of the present disclosure is a display control apparatus including: a detection block configured to detect a difference between a plurality of pixel data forming image data; and a display control block configured to control switching of the plurality of pixel data based on a detection result.

Another embodiment of the present disclosure is a display control method including: detecting a difference between a plurality of pixel data forming image data; and controlling switching of the plurality of pixel data based on a detection result.

Another embodiment of the present disclosure is a program allowing a computer to function as a display control apparatus including: a detection block configured to detect a difference between a plurality of pixel data forming image data; and a display control block configured to control switching of the plurality of pixel data based on a detection result.

The display control apparatus, display control method and program according to the embodiments of the present disclosure are capable of effectively mitigating burn-in.

### BRIEF DESCRIPTION OF THE DRAWINGS

Other features and advantageous effects of the disclosure will become apparent from the following description of embodiments with reference to the accompanying drawings.

FIG. 1 is a schematic diagram illustrating an exemplary configuration of a display system according to a first embodiment of the disclosure;

FIG. 2 is a schematic diagram illustrating a relation between a barrier position and a display position of a parallax barrier;

FIG. 3 is a schematic diagram illustrating the relation between the barrier position and the display position of the parallax barrier in another state;

FIG. 4 is a perspective view illustrating an exemplary configuration of the parallax barrier;

FIG. 5 is a flowchart representing an operation of the display system according to the first embodiment of the disclosure;

FIG. 6 is a flowchart representing another operation of the display system according to the first embodiment of the disclosure;

FIG. 7 is a schematic diagram illustrating an exemplary configuration of a display system according to a second embodiment of the disclosure;

FIG. 8 is a table showing a relation between subject distance and depth value;

FIG. 9 is a graph indicating the relation between subject distance and depth value;

FIG. 10 is a graph indicating a relation between depth value and parallax quantity;

FIG. 11 shows schematic diagrams illustrating a positional relation between a left-eye image and a right-eye image;

FIG. 12 is a flowchart representing an operation of the display system according to the second embodiment of the disclosure;

FIG. 13 is a flowchart representing another operation of the display system according to the second embodiment of the disclosure;

FIG. 14 is a schematic diagram illustrating an exemplary configuration of a display system according to a third embodiment of the disclosure;

FIG. 15 is a diagram illustrating an example of a technique for converting image data into 3D image data; and

FIG. 16 is a flowchart representing an operation of the display system according to the third embodiment of the disclosure.

### DETAILED DESCRIPTION OF THE PREFERRED EMBODIMENTS

The present disclosure will be described in further detail by way of embodiments thereof with reference to the accompanying drawings. It should be noted that, in the specification and accompanying drawings, the components having substantially the same functional configuration are denoted by the same reference code and overlapping description of those components is omitted.

In addition, herein and in the accompanying drawings, the components having substantially the same functional configurations may be distinguished from each other by attaching an alphabet to the end of the same reference code. However, if each of the components having substantially the same functional configurations need not be particularly distinguished from another, then only the same reference code is attached.

The embodiments of the present disclosure are described in the following order:
1. Configuration of the display system
2. Description of embodiments
   2-1. First embodiment
   2-2. Second embodiment
   2-3. Third embodiment
3. Conclusion

### 1. Configuration of the Display System

The technology disclosed herein may take various embodiments as will be described in chapters 2-1 to 2-3. It should be noted that, as will be described later, according to the display systems of the embodiments, 3D (three-dimensional) image data is displayed as an example of image data. However, image data applicable to the disclosed disclosure is not limited to 3D image data.

For example, even when the image data is planar image data, the technology disclosed herein can also be used. Therefore, a display control apparatus 10 according to an embodiment of the technology disclosed herein may be an apparatus having:

A. a detection block (110) configured to detect a difference between a plurality of pieces of pixel data making up image data; and

B. a display control block (130) configured to control switching of the plurality of pieces of pixel data based on a detection result obtained from the detection block (110).

According to the above-mentioned configuration, the chances of executing an unnecessary switching operation can be reduced, preventing increase of power consumption that may otherwise be caused by such switching operation. Consequently, the above-mentioned configuration provides a significant effect of efficiently mitigating the occurrence of burn-in.

It should be noted that, as described above, in each of the embodiments described below, 3D image data is displayed as an example of image data. Examples of common technologies that enable a viewer to see a 3D image without using special glasses are a parallax barrier method, a lenticular lens method, and a liquid crystal lens method.

In the above-mentioned methods, a left-eye image and a right-eye image are alternately displayed on the pixels in the horizontal direction of a display apparatus 20 (including both of the case where a collection of RGB is used as one pixel and the case where each of the RGB forms one pixel). In addition, in the above-mentioned methods, the barrier or the lens are arranged such that a left-eye image is visible to the left eye of the user and a right-eye image is visible to the right eye of the viewer, thereby providing the viewer with three-dimensionality on the basis of binocular parallax. In the embodiments described below, cases where the parallax barrier method is employed are explained.

### 2. Description of Embodiments

The configuration of the display system according to embodiments of the technology disclosed herein has been described in the above. Next, each of the embodiments of the disclosure is described in detail.

### 2-1. First Embodiment

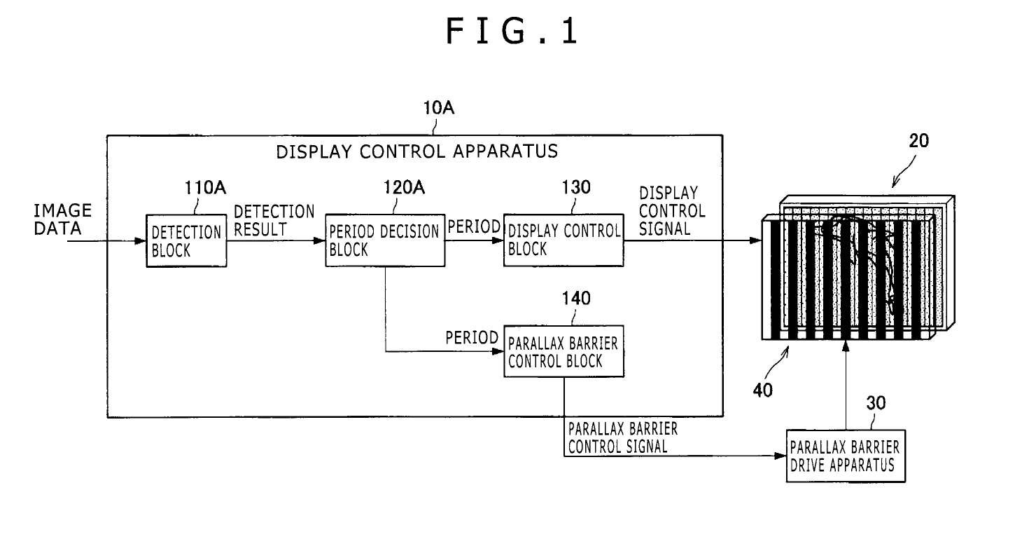

First, a first embodiment of the disclosure will be described. Referring to FIG. 1, there is shown the configuration of a display system according to the first embodiment of the disclosure. As shown in FIG. 1, the display system according to the first embodiment of the disclosure includes a display control apparatus 10A, a display apparatus 20, a parallax or disparity barrier drive apparatus 30, and a parallax or disparity barrier (or a barrier liquid crystal) 40. The display control apparatus 10A includes a detection block 110A, a period decision block 120A, a display control block 130, and a parallax or disparity barrier control block 140.

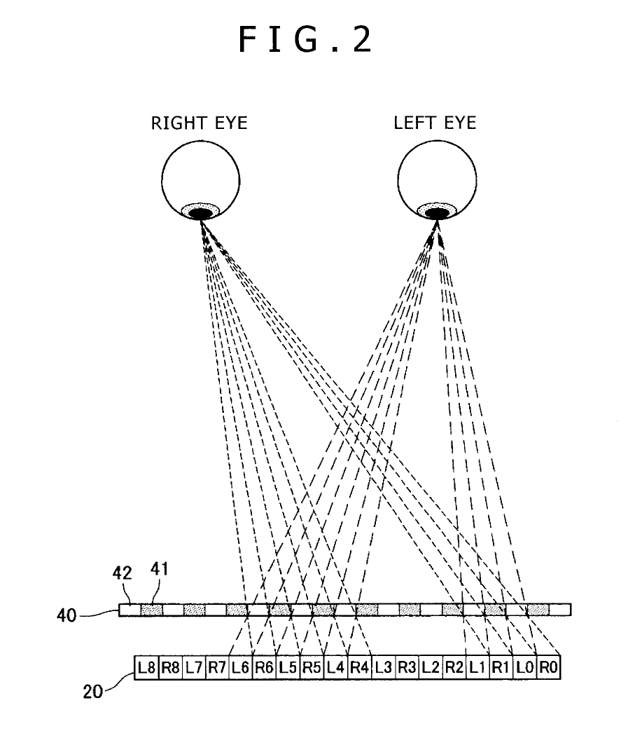

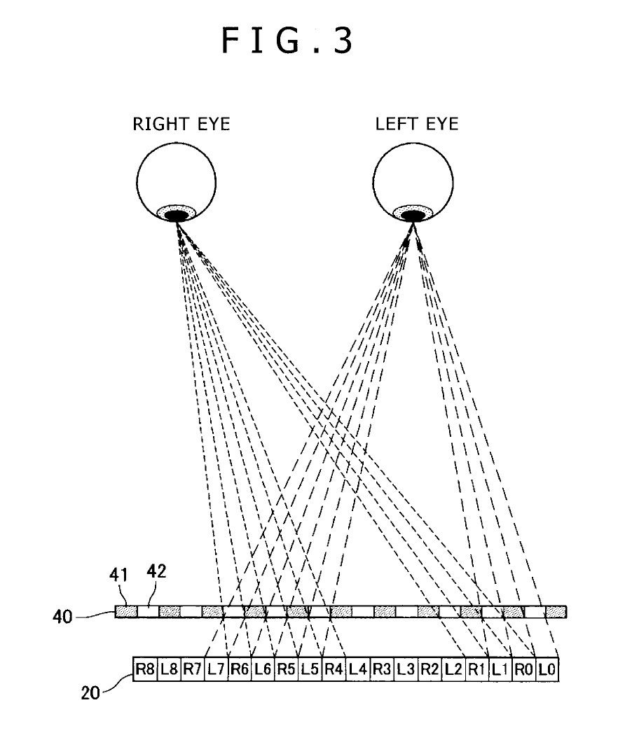

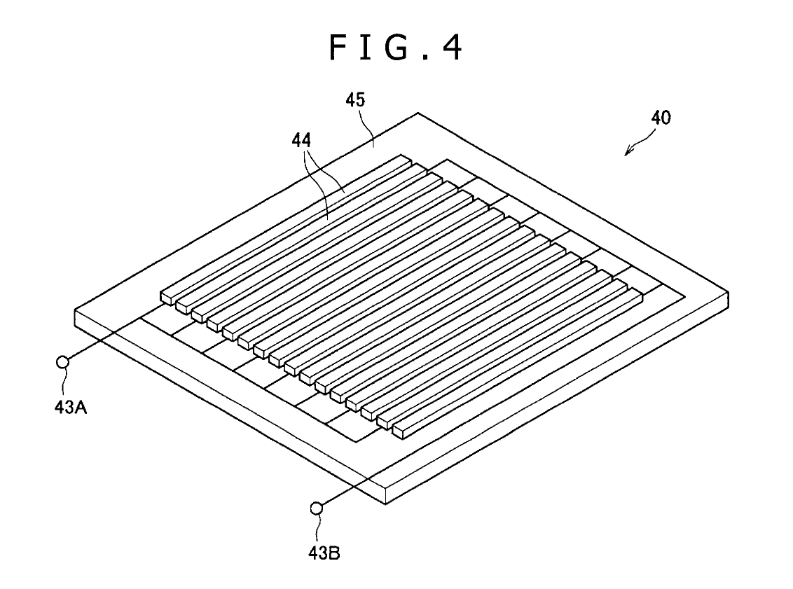

The functions of the component blocks will be described with reference to FIGS. 2 to 4. FIGS. 2 and 3 each show a relation between the position of a barrier 41 of the parallax barrier 40 and the display position of an image. Incidentally, in the examples shown in FIGS. 2 and 3, it is assumed that a collection of RGB forms a pixel. FIG. 4 shows an exemplary configuration of the parallax barrier 40.

The detection block 110A has a function of detecting the difference between a plurality of pieces of pixel data making up image data. Especially when the image data is 3D image data made up of a plurality of pieces of left-eye pixel data and the a plurality of pieces of right-eye pixel data, the detection block 110A has a function of detecting the difference between the adjacent left-eye pixel data and right-eye pixel data. Various kinds of data are assumed as specific examples of the difference between the adjacent left-eye pixel and right-eye pixel data. Among those kinds of data, the detection block 110A in the first embodiment of the disclosure may detect the difference in luminance component between the adjacent left-eye pixel data and right-eye pixel data.

As an example of the image data, FIG. 2 and FIG. 3 show 3D image data constituted by left-eye pixel data L0, L1, . . . , L8 and right-eye pixel data R0, R0, . . . , R8 arranged alternately in the horizontal direction. However, the number of the pieces of horizontally arranged left-eye pixel data and the number of the pieces of horizontally arranged right-eye pixel data are not limited to a specific value as far as there are a plurality of data pieces.

The detection block 110A can detect the difference between, for example, adjacent left-eye pixel data L0 and right-eye pixel data R0. Similarly, the detection block 110A can detect the differences between the other adjacent left-eye pixel data and right-eye pixel data. The image data may be obtained by imaging using an imaging apparatus not shown, from a record media not shown, or from any other appropriate apparatus not shown.

The detection block 110A may detect the difference for any area in one frame of image data. For example, the detection block 110A may detect the difference over the whole area of one frame of image data. Alternatively, the detection block 110A may detect the difference for part of the area of one frame of image data. If the detection area is to be part of the area of one frame of image data, the partial area to be subjected to detection may be determined in advance. For example, the partial area may be the central area of one frame of image data.

The display control block 130 has a function of controlling the switching of the adjacent left-eye pixel data and right-eye pixel data based on a detection result provided by the detection block 110A. For example, before switching, the display control block 130 may control the display in such a manner that the pieces of pixel data are displayed in the sequence of R0, L0, R1, L1, . . . , R8, L8 as shown in FIG. 2. After switching, the display control block 130 may control the display in such a manner that the pieces of pixel data are displayed in the order of L0, R0, L1, R1 . . . , L8, R8 as shown in FIG. 3.

However, the method of switching is not limited to this method. For example, the display control block 130 may slide R0, L0, R1, L1, . . . , R8, L8 in one direction. To be more specific, the display control block 130 may change the positions without changing the arrangement sequence of R0, L0, R1, L1, . . . , R8, L8.

The parallax barrier control block 140 has a function of controlling the position change of the barrier 41 constituting the parallax barrier 40. The barrier 41 constituting the parallax barrier 40 has a property of blocking light and an opening 42 of the parallax barrier 40 has a property of transmitting light. Using these properties, the parallax barrier control block 140 needs to control the position of the barrier 41 such that the light beams emitted from R0, R1, . . . , R8 directly reach the right eye but not directly reach the left eye, and the light rays emitted from L0, L1, . . . , L8 directly reach the left eye but not directly reach the right eye, as shown in FIGS. 2 and 3.

Therefore, if the display control block 130 controls switching of adjacent left-eye pixel data and right-eye pixel data, the position change of the barrier 41 of the parallax barrier 40 should be controlled accordingly.

The display apparatus 20 has a function of displaying 3D image data based on the control by the display control block 130. To be more specific, the display apparatus 20 receives a display control signal from the display control block 130 and, based on the obtained display control signal, displays left-eye pixel data and right-eye pixel data and switches left-eye pixel data and right-eye pixel data.

The parallax barrier 40 is formed of a liquid crystal panel and has an electrode structure including a planar common electrode 45 and a plurality of barrier control electrodes 44 extending in stripes and disposed oppositely to the common electrode 45 via a liquid crystal layer. In addition, the parallax barrier 40 is configured such that the plurality of barrier control electrodes 44 are applied with voltage.

As shown in FIG. 4, alternate lines of the barrier control electrodes 44 are connected via wiring. In the example illustrated in FIG. 4, the odd-number barrier control electrodes 44 from the left side are connected to a first input terminal 43A. On the other hand, as shown in FIG. 4, the even-number barrier control electrodes 44 from the left are connected to a second input terminal 43B. In other words, the plurality of barrier control electrodes 44 are configured such that alternate electrodes are applied with the same voltage.

The parallax barrier drive apparatus 30 changes the position of the barrier 41 of the parallax barrier 40 based on the control by the parallax barrier control block 140. To be more specific, the parallax barrier drive apparatus 30 receives a parallax barrier control signal from the parallax barrier control block 140 and, based on the obtained parallax barrier control signal, changes the position of the barrier 41 of the parallax barrier 40.

For example, the parallax barrier drive apparatus 30 applies different voltages to the first input terminal 43A and the second input terminal 43B to form light transmission sections and light blocking sections (or the barrier) in stripes, thereby realizing 3D display. In other words, the parallax barrier drive apparatus 30 switches the voltages applied to the first input terminal 43A and the second input terminal 43B so as to change barrier positions in accordance with the pixel switching.

The functions described above allow reduction of the chances of an unnecessary switching operation, thereby preventing increase of power consumption as in the case where image data is planar image data. Therefore, the configuration described above provides the effect of efficiently mitigating burn-in.

The methods of the control by the display control block 130 and the parallax barrier control block 140 are not particularly restricted. For example, the period decision block 120A has a function of determining a period in accordance with a detection result provided by the detection block 110A. Therefore, the display control block 130 may control the switching of adjacent left-eye pixel data and right-eye pixel data in accordance with a period determined by the period decision block 120A. In this case, the parallax barrier control block 140 may control the position change of the barrier 41 of the parallax barrier 40 in accordance with the period determined by the period decision block 120A.

It should also be noted that the method of the period determination by the period decision block 120A is not restricted to a particular method. For example, the period decision block 120A may execute period determination in accordance with an occurrence frequency of a pair of adjacent left-eye pixel data and right-eye pixel data whose difference detected by the detection block 110A exceeds a difference comparison value. The difference comparison value may be determined in advance. The pair of the adjacent left-eye pixel dada and right-eye pixel data refers to, in the examples of FIG. 2 and FIG. 3, R0 and L0, and likewise each of R1 and L1, R8 and L8 forms a pair.

The period determination in accordance with the occurrence frequency may be executed in a variety of manners. For example, it can be considered that the control by the display control block 130 and the parallax barrier control block 140 should be executed in a shorter time the higher the occurrence frequency is, so that the period decision block 120A can determine a short period. Alternatively, if the occurrence frequency falls below the frequency comparison value, the period decision block 120A may determine not to execute the switching control by the display control block 130 and the changing control by the parallax barrier control block 140.

The computation of occurrence frequency may be carried out in various manners. For example, regardless of a difference detected by the detection block 110A, the period decision block 120A may compute the occurrence frequency by accumulating a same value (1 for example) as a count value. However, the count value may not be a same value.

For example, the period decision block 120A may weight the count value in accordance with the size of a difference detected by the detection block 110A, and compute the occurrence frequency based on the weighted count value. For example, if the size of the difference detected by the detection block 110A is 60 or higher, then the period decision block 120A may accumulate the count value as 1, and if the size of the difference is 30 or higher and less than 60, then the period decision block 120A may accumulate the count value as 0.5.

The period decision block 120A may execute period determination in accordance with a total value of the differences detected by the detection block 110A with respect to each pair of adjacent left-eye pixel data and right-eye pixel data. In the examples shown in FIG. 2 and FIG. 3, the period decision block 120A may execute period determination in accordance with a total value of the differences of the pairs R0 and L0, . . . , R8 and L8. For example, it can be considered that the control by the display control block 130 and the parallax barrier control block 140 need not be executed for a longer time the smaller the total value is, so that the period decision block 120A may determine a long period.

The intervals at which the detection block 110A executes the detection may be changed as appropriate. For example, the detection block 110A may execute the next detection after elapse of a time period in accordance with the current detection result. To be more specific, the detection block 110A may execute the next detection after elapse of a time period in accordance with the occurrence frequency of a pair of adjacent left-eye pixel data and right-eye pixel data whose difference detected the current time exceeds the difference comparison value.

To be more specific, for example, it can be considered that, the lower the occurrence frequency is, the control by the display control block 130 and the parallax barrier control block 140 need not be executed for a longer time, so that the next detection may be executed after elapse of a long period of time. For example, if the occurrence frequency is 30 times/frame or higher and less than 60 times/frame, then the detection block 110A may execute the detection every two minutes; if the occurrence frequency is 60 times/frame or higher, then the detection block 110A may execute the detection every one minute.

As another technique, the detection block 110A may detect the difference at time intervals in accordance with a continuous display time of image data. For example, it can be said that when image data is being displayed continuously for a long time, burn-in is likely to occur. Therefore, the longer the continuous display time of the image data, the detection block 110A may detect the difference at a shorter time interval.

For example, if the continuous display time is less than five minutes, then the detection block 110A may execute the detection every three minutes. If the continuous display time is 10 minutes or higher and less than 15 minutes, then the detection block 110A may execute the detection every two minutes, for example. If the continuous display time is 15 minutes or higher, then the detection block 110A may execute the detection every minute, for example.

The functions of the component blocks of the display system according to the first embodiment of the present disclosure have been described so far. Next, an operation flow of the display system according to the first embodiment of the disclosure is described.

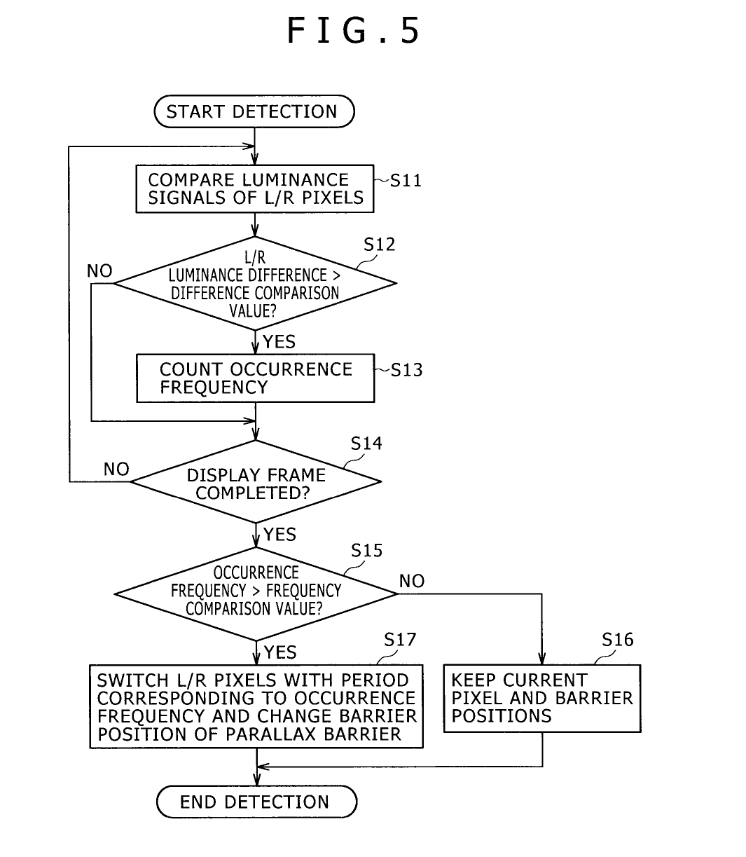

Referring to FIG. 5, there is shown a flowchart of an operation flow of the display system according to the first embodiment of the present disclosure. The following describes the operation flow of the display system according to the first embodiment of the disclosure with reference to FIG. 5. It should be noted that a right-eye pixel and a left-eye pixel that are adjacent to each other in the horizontal direction are sometimes represented as L/R pixels.

First, image data entered in the detection block 110A is displayed in a sequence of R0, L0, R1, L1, R2, L2, . . . R8, L8 in the horizontal direction of the display apparatus 20 so as to provide a viewer with a 3D image. In the detection block 110A, a comparison is made between right-eye pixel data and left-eye pixel data that are adjacent to each other in the horizontal direction with respect to the luminance signals (e.g., a luminance signal of YUV or an RGB signal of pixel data) of these pieces of image data, thereby detecting the difference as, for example, “difference between R0 and L0” (step S11). The difference detected by the detection block 110A is outputted to the period decision block 120A as a detection result.

The period decision block 120A determines whether the difference is greater than a preset difference comparison value (step S12). If the different is found to be greater than the difference comparison value (Yes in step S12), then the period decision block 120A counts an occurrence frequency (step S13). It should be noted that, every time step S13 is executed, the count value is accumulated, thereby computing the occurrence frequency. On the other hand, if the difference is lower than the difference comparison value (No in step S12), then the period decision block 120A proceeds to step S14.

If steps S11 to S13 have not been completed for the display frame (No in step S14), then the period decision block 120A returns to step S11 to execute steps S11 to S13 on the next pixel data (for example, after the processing of R0 and L0, the processing of R1 and L1). On the other hand, if steps S11 to S13 have been completed for the display frame (Yes in step S14), then the period decision block 120A proceeds to step S15.

For example, if the luminance signal of image data is a value ranging from 0 to 255, and when R0 is 255 and L0 is 128, the difference between R0 and L0 is 127; if the preset frequency comparison value is 64, the difference is greater than the frequency comparison value. Thus, the count value will be added. Namely, the number of pixels whose difference (the difference between R pixel and L pixel) is greater than the preset value in the display frame is counted.

The timing at which the difference is detected by the detection block 110A is not especially restricted to a particular timing; for example, the difference may be detected regularly (e.g., the detection is executed for particular frames) or at any state transition timing, such as a time at which an image to be reproduced by an imaging apparatus is switched (image feed or rewind), a reproduction start time, a reproduction stop time, a recording start time, a recording stop time, and a zooming time.

If the occurrence frequency is greater than the preset frequency comparison value (Yes in step S15), then the period decision block 120A determines a period in accordance with the occurrence frequency, the display control block 130 controls the switching of L pixel and R pixel at the determined period, and the parallax barrier control block 140 controls the position change of the barrier 41 of the parallax barrier 40. Based on the control by the display control block 130, the display apparatus 20 switches L pixel and R pixel and the parallax barrier 40 changes the position of the barrier 41 of the parallax barrier 40 under the control of the parallax barrier control block 140 (step S17). Then, the detection by the display object 110 terminates.

For example, the period to be determined by the period decision block 120A is determined shorter the larger the occurrence frequency. The period decision block 120A may compute a period (the number of frames) from equation (1) below.

Period (the number of frames)=Reference Period−Period (a value based on occurrence frequency) (1)

In equation (1), the reference period is a value set to the period decision block 120A in advance. The period (a value based on occurrence frequency) is obtained by multiplying the computed occurrence frequency by a preset coefficient, for example. If the period (a value based on occurrence frequency) is 30 and the reference period is 60, the period (the number of frames) becomes 30. The switching of L/R pixels and the position change of the barrier 41 of the parallax barrier 40 are then executed every time 30 frames are displayed on the display apparatus 20. Thereafter, the switching of L/R pixel and the position change of the barrier 41 of the parallax barrier 40 are executed in a period of 30 frames until the next detection.

According to the period decision method as described above, for example, the luminance differences between adjacent L/R pixels can be equalized in a short time the more fixed patterns (ODS or an object) brighter than a dark background are displayed in 3D display. In addition, another period decision method may be used in which period determination is executed based on an accumulated difference value and an occurrence frequency.

In this case, for example, the period decision block 120A accumulates, in the display frame, differences greater than the preset difference comparison value to determine a period in accordance with the accumulated difference value and the occurrence frequency. The period decision block 120A may compute a period (the number of frames) from equation (2) below. The period (a value based on occurrence frequency and accumulated difference value) is obtained by multiplying a total of occurrence frequency and accumulated difference value by a preset coefficient, for example.

Period (the number of frames)=Reference Period−Period (a value based on occurrence frequency and accumulated difference value) (2)

According to this period determination method, a short period is determined if the luminance difference between the adjacent L/R pixels is large and the occurrence frequency is large. Therefore, even if the occurrence frequencies are the same, the luminance difference between adjacent L/R pixels can be equalized in a shorter time period the larger the luminance difference between the adjacent L/R pixels is.

On the other hand, if the occurrence frequency is below the preset frequency comparison value (No in step S15), then the switching of L/R pixels and the position change of the barrier 41 of the parallax barrier 40 are not executed periodically, and the current state is continued (step S16). Then, the detection by the detection block 110 terminates.

The operation flow of the display system according to the first embodiment of the present disclosure has been described so far. It should be noted that the operation flow of the display system according to the first embodiment of the present disclosure do not need to be the same as the operation flow described above with reference to FIG. 5, and this operation flow may be altered as appropriate. The following describes an exemplary variation to the operation flow of the display system according to the first embodiment of the present disclosure.

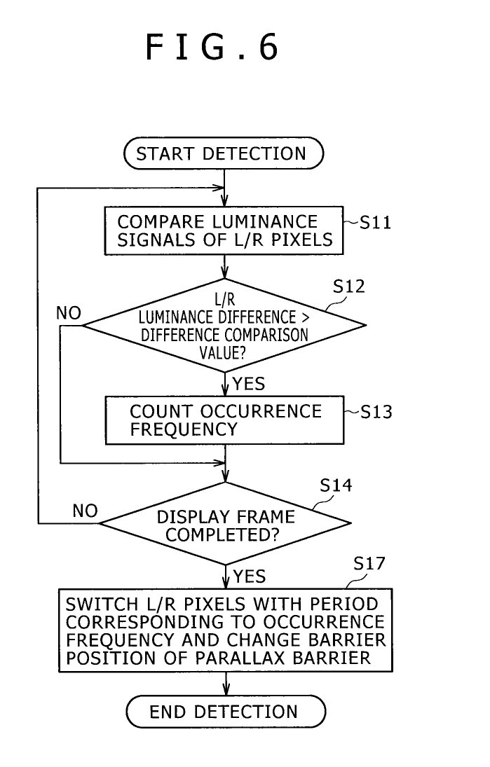

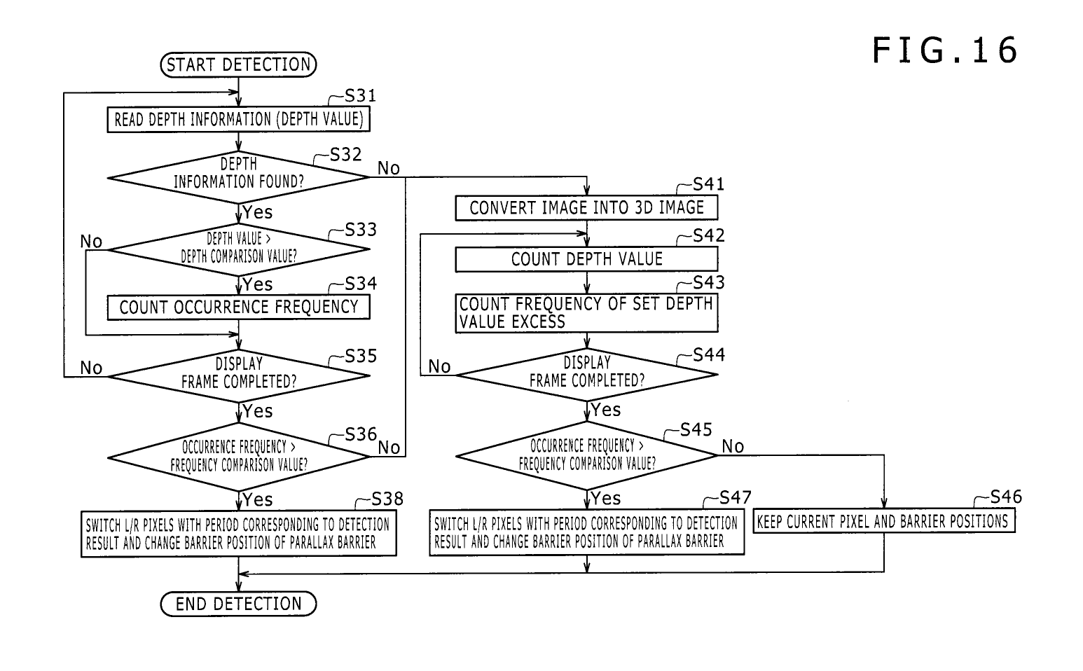

FIG. 6 shows an exemplary variation to the operation flow shown in FIG. 5. As shown in FIG. 6, steps S15 and S16 shown in FIG. 16 may be omitted. To be more specific, the period decision block 120A omits the comparison between occurrence frequency and frequency comparison value (step S15) and, if steps S11 through S13 for the display frame have been completed (Yes in step S14), it may uniformly execute the switching of L/R pixels and the position change of the barrier 41 of the parallax barrier 40 at a period according to the occurrence frequency.

As described above, according to the first embodiment of the present disclosure, when the image data is 3D image data, chances of an unnecessary switching operation can be lowered as in the case where the image data is planar image data, thereby preventing increase in power consumption caused by such switching. Consequently, the above-mentioned configuration provides the effect of efficiently mitigating burn-in.

### 2-2. Second Embodiment

The following describes the second embodiment of the disclosure. As described above, in the first embodiment of the disclosure, a difference between the luminance components of L/R pixels is detected and, in accordance with the detected difference, the switching of L/R pixels and the position change of the barrier 41 of the parallax barrier 40 are controlled. In the second embodiment of the disclosure, depth values of left-eye pixel data or right-eye pixel data are detected and, based on the detected depth values, the switching of L/R pixels and the position change of the barrier 41 of the parallax barrier 40 are controlled.

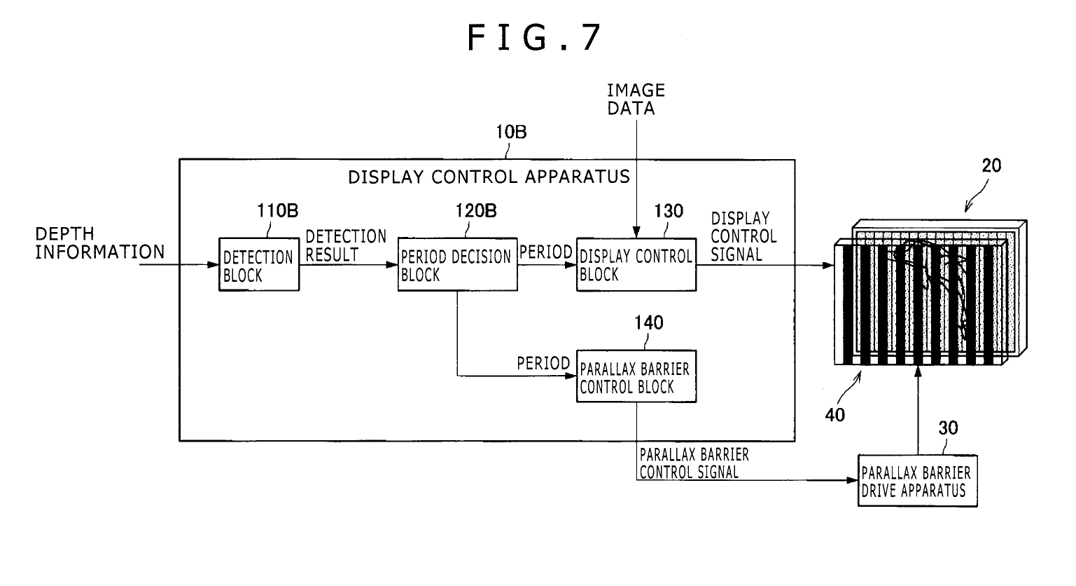

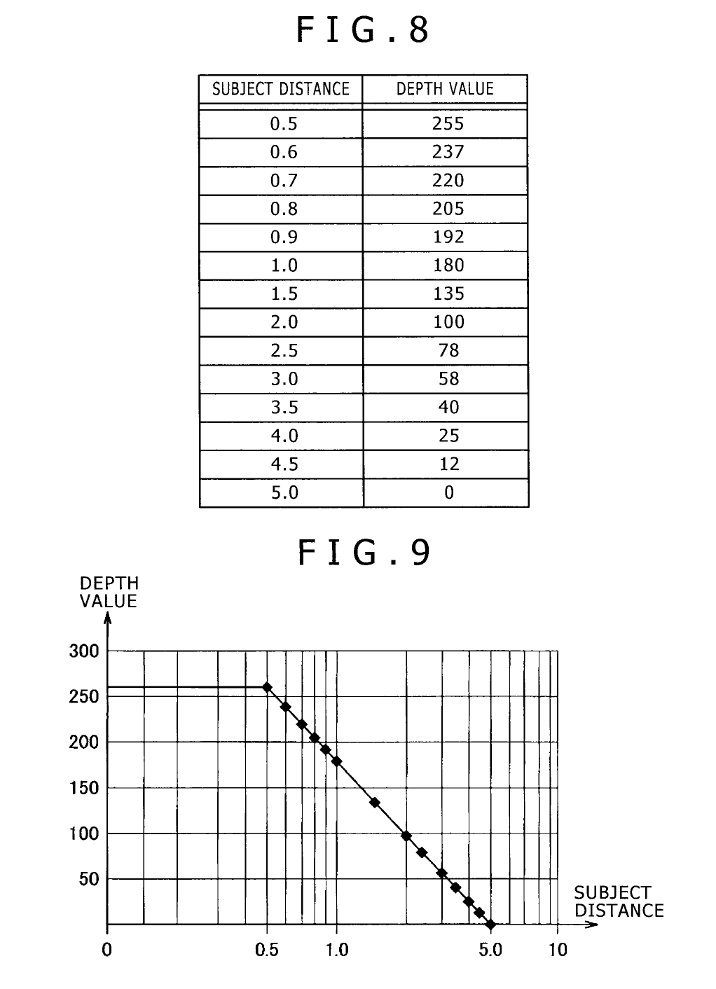

FIG. 7 shows an exemplary configuration of a display system according to the second embodiment of the disclosure. As shown in FIG. 7, a display control apparatus 10B according to the second embodiment of the disclosure is different from the display control apparatus 10A of the first embodiment of the disclosure. Especially, a detection block 110B and a period decision block 120B of the display control apparatus 10B are different from the detection block 110A and the period decision block 120A, respectively. The following describes functions of the detection block 110B and the period decision block 120B with reference to FIG. 8 to FIG. 11.

The detection block 110B has a function of detecting a depth value of each left-eye pixel data or right-eye pixel data as a difference between the adjacent left-eye pixel data and right-eye pixel data. The depth value is given to each pixel (a pair of left-eye pixel data and right-eye pixel data) and depth information is a collection of the depth values of pixels.

FIG. 8 shows a table of a relation between subject distance and depth value. FIG. 9 shows a graph of a relation between subject distance and depth value. As shown in FIG. 8 and FIG. 9, the depth value takes a value ranging from 0 to 255 with respect to the subject distance, and as the subject distance becomes shorter, the depth value becomes larger. The subject distance is equivalent to a distance from an imaging position to a subject included in the captured image. Details of a technique for generating depth information are disclosed in Japanese Patent Laid-open No. 2011-199084, for example. The depth information herein may be generated by the generating technique disclosed in this reference document.

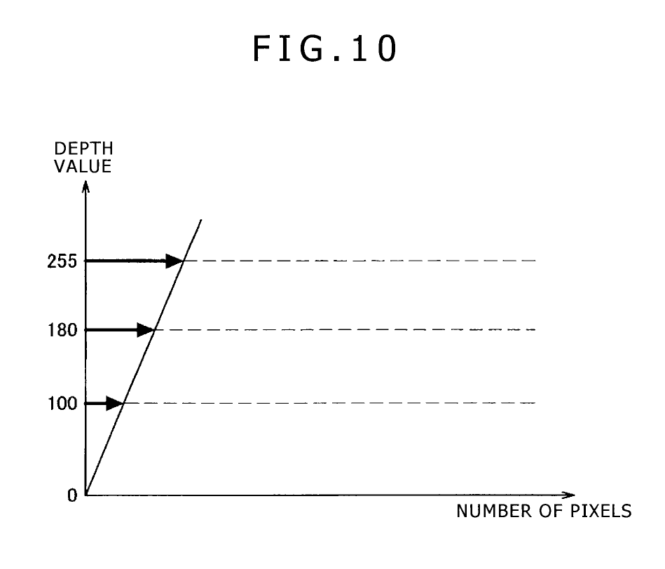

Referring to FIG. 10, there is shown a graph indicating a relation between depth value and parallax quantity. The parallax or disparity quantity denotes the amount of deviation of corresponding pixels between left-eye image and right-eye image, which is expressed by a number of pixels as shown in FIG. 10, for example. As shown in FIG. 10, the larger the depth value is, the deviation in corresponding pixels between left-eye image and right-eye image becomes larger.

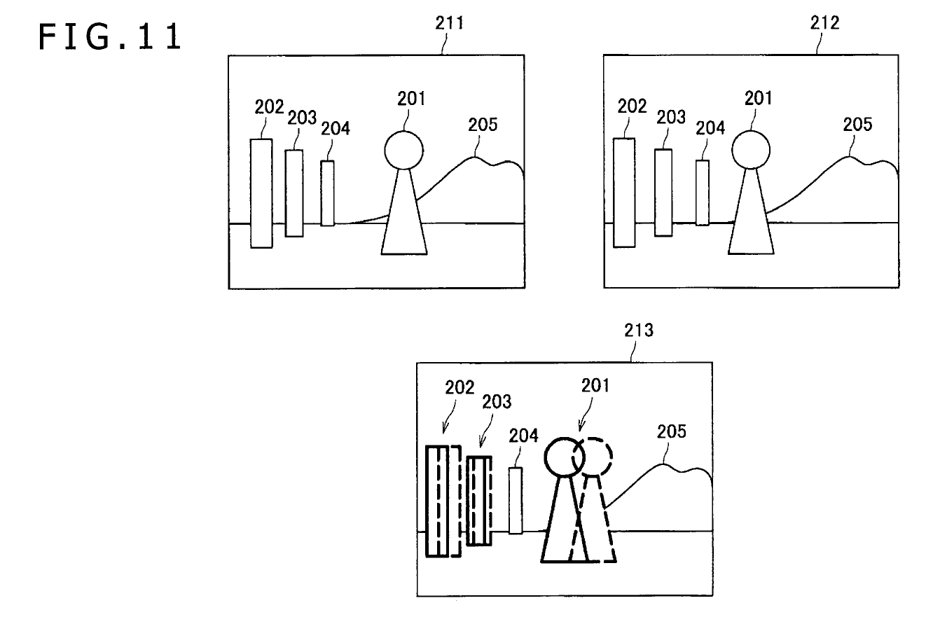

Referring to FIG. 11, there is shown a positional relation between left-eye image and right-eye image in a schematic manner. As shown in FIG. 11, in each of a left-eye image 211 and a right-eye image 212, there are a person 201, sticks 202 through 204, and a mountain 205. In a superimposed image 213 obtained by superimposing the left-eye image 211 with the right-eye image 212, of the lines indicating the outlines of the objects (the person 201 and sticks 202 and 203), the thick lines indicate the outlines of the objects present in the right-eye image and the broken lines indicate the outlines of the objects present in the left-eye image.

In the example shown in FIG. 11, the depth value of the person 201 is 255, and there is a large deviation between the left and right images. The depth value of the stick 203 is 12, which means that there is a small deviation between the left and right images, and the depth value of the mountain 205 is 0, which means that there is no deviation between the left and right images. Thus, because there is a correlation between parallax quantity and depth value, the detection of depth values allows the detection of deviations between objects displayed in the left-eye and right-eye images. For example, when the person 201 is focused, since there is a large deviation between the left and right images, it is assumed that the possibility of occurrence of a difference between the adjacent left-eye pixel data and right-eye pixel data is high.

As described above, the larger the depth value, the deviation between left and right images becomes larger (namely, a parallax quantity becomes larger). Therefore, since there is a correlation between depth value and parallax quantity, the detection block 110B can detect a depth value of each of left-eye pixel data or right-eye pixel data as a difference between the adjacent left-eye pixel data and right-eye pixel data.

In addition, in the second embodiment of the disclosure, since the detection block 110B detects a depth value of each of the left-eye pixel data or the right-eye pixel data as a difference between the adjacent left-eye pixel data and right-eye pixel data, the period decision block 120B can determine a period in accordance with the occurrence frequency of left-eye pixel data or right-eye pixel data whose depth value detected by the detection block 110B exceeds a depth comparison value. The depth comparison value may be determined in advance.

As with the first embodiment of the disclosure, there are assumed a variety of techniques for occurrence frequency computation in the second embodiment of the disclosure. For example, the period decision block 120B may compute the occurrence frequency by accumulating the same value (1 for example) as a count value regardless of a difference detected by the detection block 110B. However, the count value may not be a same value.

For example, the period decision block 120B may weight the count value in accordance with the size of a depth value detected by the detection block 110B to compute the occurrence frequency based on the weighted count value. For example, if the size of a depth value detected by the detection block 110B is 60 or higher, then the period decision block 120B may accumulate the count values as 1; if the size of a depth value is 30 or higher and less than 60, then the period decision block 120B may accumulate the count values as 0.5.

The period decision block 120B may determine a period in accordance with a total value of the depth values detected by the detection block 110B. In the examples shown in FIG. 2 and FIG. 3, the period decision block 120B may determine a period in accordance with a total value of the depth values of R0, . . . , R8. For example, it can be considered that, the smaller the total value, the control by the display control block 130 and the parallax barrier control block 140 need not be executed for a longer time, so that the period decision block 120B may determine a long period.

The functions of the detection block 110B and the period decision block 120B according to the second embodiment of the disclosure have been described so far. Next, an operation flow of the display system according to the second embodiment of the disclosure is described.

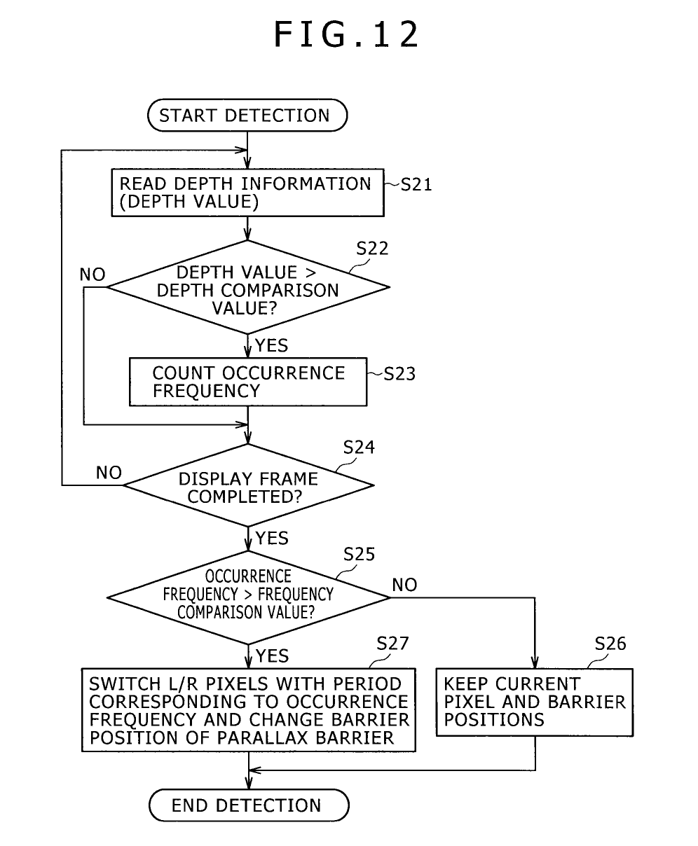

FIG. 12 shows a flowchart of an operation of the display system according to the second embodiment of the disclosure. The following describes the flow of an operation of the display system according to the second embodiment of the disclosure with reference to FIG. 12. Incidentally, as with the first embodiment of the disclosure, right-eye pixel and left eye pixel that are adjacent to each other in the horizontal direction may be referred to as L/R pixels.

First, depth information is generated by, for example, the technique described above, and the generated depth information is read out by the detection block 110B (step S21). As described above, the depth information is a collection of the depth values of pixels. The depth information detected by the detection block 110B is outputted to the period decision block 120B as a detection result.

The period decision block 120B determines whether a depth value is greater than a preset depth comparison value (step S22). If the depth value is found to be greater than the preset depth comparison value (Yes in step S22), then the period decision block 120B counts the occurrence frequency (step S23). It should be noted that, every time step S23 is executed, count values are accumulated to compute the occurrence frequency. On the other hand, if the depth value is smaller than the depth comparison value (No in step S22), then the period decision block 120B proceeds to step S24.

If steps S21 through S23 have not been completed for the display frame (No in step S24), then the period decision block 120B returns to step S21 to execute steps S21 through S23 on the next pixel data (e.g., after the processing of R0, the processing of R1). On the other hand, if steps S21 through S23 have been completed for the display frame (Yes in step S24), then the period decision block 120B proceeds to step S25.

The timing at which the depth information is detected by the detection block 110B is not especially restricted to a particular timing; for example, depth information may be detected regularly (e.g., depth information is read upon detection of a particular frame) or at any other state transition timing, such as a time at which an image to be reproduced by an imaging apparatus is switched (image feed or rewind), a reproduction start time, a reproduction stop time, a recording start time, a recording stop time, and a zooming time.

If the occurrence frequency is greater than a preset frequency comparison value (Yes in step S25), the period decision block 120B determines a period in accordance with the occurrence frequency. The display control block 130 controls the switching of L pixel and R pixel at the determined period, and the parallax barrier control block 140 controls the position change of the barrier 41 of the parallax barrier 40. Under the control of the display control block 130, the display apparatus 20 executes the switching of L pixel and R pixel, and under the control of the parallax barrier control block 140, the parallax barrier 40 changes the positions of the barrier 41 of the parallax barrier 40 (step S27). Then, the detection by the detection block 110B terminates.

For example, a period to be determined by the period decision block 120B is determined shorter the larger the occurrence frequency. The period decision block 120B may compute a period (the number of frames) from equation (1) described above. The period (a value based on occurrence frequency) is obtained by multiplying the computed occurrence frequency by a preset coefficient, for example.

According to such period determination method, for example, by detecting the occurrence frequency of a pixel whose depth value is large in the display frame, it can be determined that, the larger the occurrence frequency is, a range of pixels with deviation between objects displayed in the left-eye image and right-eye image is large. In addition, the larger the range of deviation is, the luminance difference between the adjacent pixels of a fixed pattern portion can be averaged in a shorter time. Further, as another period determination technique, a technique in which a period is determined based on an accumulated depth value and occurrence frequency may be adopted as well.

In this case, the period decision block 120B accumulates the depth values greater than a preset depth comparison value for the display frame, and determines a period in accordance with the accumulated depth value and the occurrence frequency. The period decision block 120B may compute a period (the number of frames) from equation (3) below. The period (a value based on occurrence frequency and accumulated depth value) is obtained by multiplying a total of occurrence frequency and accumulated value by a preset coefficient, for example.

Period (the number of frames)=Reference Period−Period (a value based on occurrence frequency and accumulated depth value) (3)

According to this period determination technique, for example, a short period is detected when the depth value is large and the occurrence frequency is large. Therefore, even when the occurrence frequencies are the same, the luminance difference between adjacent L/R pixels can be averaged in a shorter time the larger the depth value (or the larger the parallax quantity).

On the other hand, if the occurrence frequency is below a preset frequency comparison value (No in step S25), then the switching of L/R pixels and the position change of the barrier 41 of the parallax barrier 40 are not executed but the current state is continued (step S26). Then, the detection by the detection block 110B terminates.

A flow of an operation of the display system according to the second embodiment of the disclosure has been described so far. However, it should be noted that the flow of an operation of the display system according to the second embodiment may not be the same as that described above with reference to FIG. 12, and may be changed as appropriate. The following describes an exemplary variation to the operation of the display system according to the second embodiment of the disclosure.

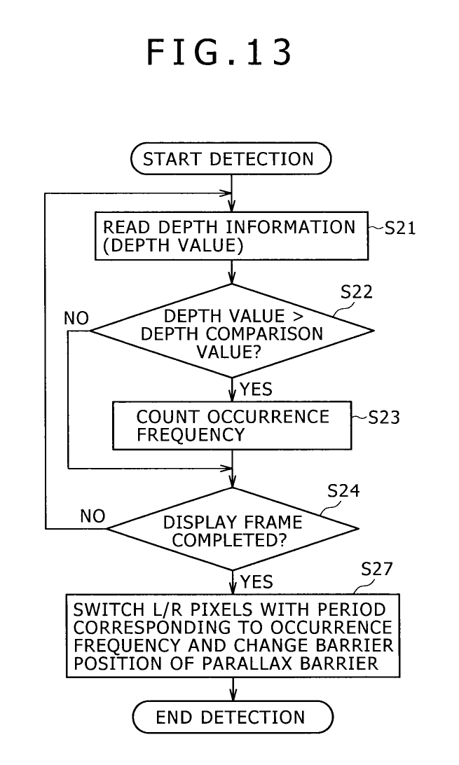

FIG. 13 shows an exemplary variation to the flow of the operation described above with reference to FIG. 12. As shown in FIG. 13, steps S25 and S26 of FIG. 12 may be omitted. To be more specific, the period decision block 120B may omit the comparison (step S25) between occurrence frequency and frequency comparison value and, if steps S21 through S23 have been completed for the display frame (Yes in step S24), it may uniformly execute the switching of L/R pixels and the position change of the barrier 41 of the parallax barrier 40 at a period in accordance with the occurrence frequency.

As described above, according to the second embodiment of the disclosure, if the image data is 3D image data, chances of an unnecessary switching operation can be lowered as in the case where the image data is planar image data, thereby preventing increase of power consumption caused by such switching. Consequently, the above-mentioned novel configuration provides the effect of efficiently mitigating burn-in.

### 2-3. Third Embodiment

Next, the third embodiment of the disclosure is described. As described above, in the second embodiment of the disclosure, the depth values of left-eye image data or right-eye image data are detected and, in accordance with the detected depth values, the switching of L/R pixels and the position change of the barrier 41 of parallax barrier 40 are controlled. In the third embodiment of the disclosure, when there is no depth information, or when depth information exists but the parallax quantity is small, the image data is converted into 3D image data so as to obtain depth information. For example, when image data is 2-dimensional image data, no depth information exists.

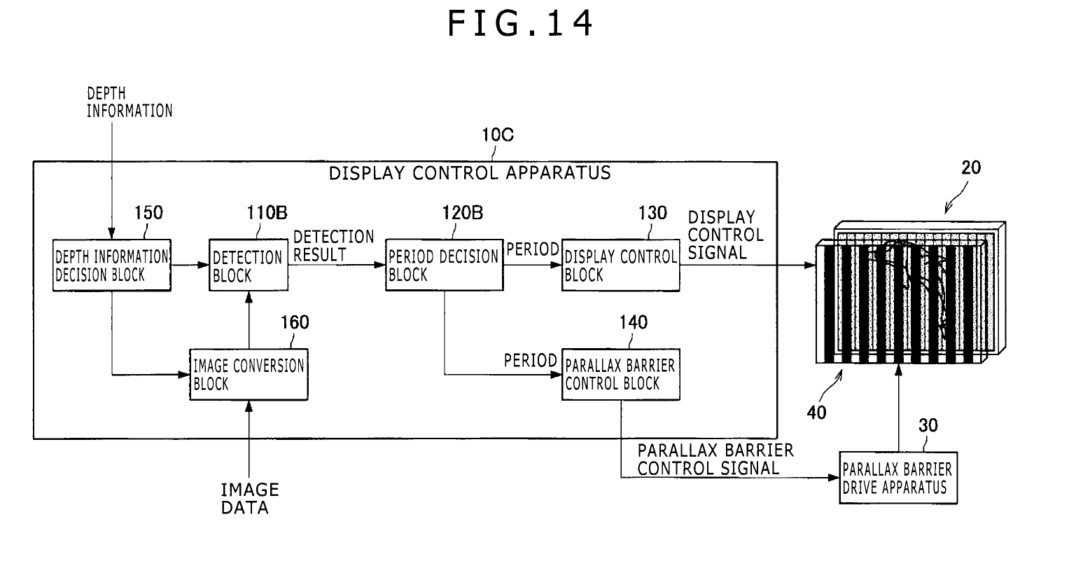

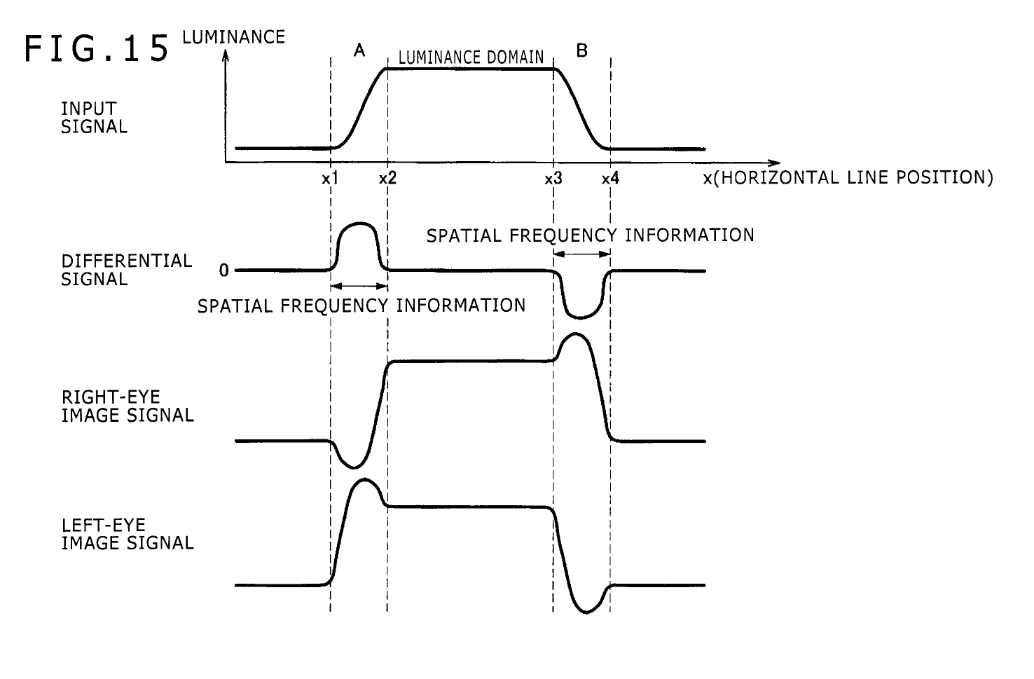

FIG. 14 shows an exemplary configuration of a display system according to the third embodiment of the disclosure. As shown in FIG. 14, a display control apparatus 10C according to the third embodiment of the disclosure is different from the display control apparatus 10A and the display control apparatus 10B. Particularly, the display control apparatus 10C is different from the display control apparatus 10A and the display control apparatus 10B in that it includes a depth information decision block 150 and an image conversion block 160. The following describes functions of the depth information decision block 150 and the image conversion block 160 with reference to FIG. 15.

The depth information decision block 150 has a function of determining whether depth information exists or not. In addition, when depth information is determined to exist, the depth information decision block 150 may determine whether the occurrence frequency of left-eye pixel data or right-eye pixel data whose depth value exceeds a depth comparison value is below the frequency comparison value or not. The depth information decision block 150 can read out depth information using the same technique as that described with reference to the second embodiment of the disclosure. For example, the existence of depth information is determined by determining whether the depth information has been read out or not.

When depth information is determined not to exist by the depth information decision block 150, the image conversion block 160 converts image data into 3D image data. In addition, when the depth information decision block 150 determines that depth information exists, and that the occurrence frequency of left-eye pixel data or right-eye pixel data whose depth value exceeds a depth comparison value is determined to be below the frequency comparison value, the image conversion block 160 may convert the image data into 3D image data.

Details of a technique for converting image data into 3D image data are disclosed in Japanese Patent Laid-open No. 2010-63083, for example. The conversion from image data into 3D image data may be executed by this conversion technique.

FIG. 15 shows diagrams illustrating an example of the technique of converting image data into 3D image data. As shown in FIG. 15, the image conversion block 160 uses a differential or derivative signal generated from image data (corresponds to the input signal shown in FIG. 15) to convert the image data into 3D image data. In addition, as shown in FIG. 15, a spatial frequency information part of this differential or derivative signal is equivalent to a deviation (or the number of pixels) between a right-eye image and left-eye image. This spatial frequency information part may therefore be regarded as a subject distance (or a depth value). If image data is 3D image having a small parallax quantity, the image conversion block 160 generates a left-eye image and a right-eye image having parallax from the right-eye image or the left-eye image.

FIG. 16 shows a flowchart indicating the flow of an operation of the display apparatus according to the third embodiment of the disclosure. The following describes the flow of an operation of the display apparatus according to the third embodiment of the disclosure with reference to FIG. 16. It should be noted that a right-eye pixel and left-eye pixel adjacent to each other in the horizontal direction are sometimes noted as L/R pixels as with the first embodiment and the second embodiment of the disclosure.

First, depth information is generated by the technique described above and the generated depth information may be read out by the depth information decision block 150 (step S31). As described above, depth information is a collection of the depth values of pixels. The depth information decision block 150 determines whether depth information exists or not (step S32). If no depth information is determined to exist by the depth information decision block 150 (No in step S32), the period decision block 120B proceeds to step S41. On the other hand, if depth information is determined to exist by the depth information decision block 150 (Yes in step S32), the depth information is detected by the detection block 110B and outputted to the period decision block 120B as a detection result. The process then proceeds to step S33.

The period decision block 120B determines whether the depth value is greater than a preset depth comparison value or not (step S33). If the depth value is found to be greater than the preset depth comparison value (Yes in step S33), then the period decision block 120B counts the occurrence frequency (step S34). It should be noted that every time step S34 is executed, count values are accumulated, thereby computing an occurrence frequency. On the other hand, if the depth value is found to be below the depth comparison value (No in step S33), then the period decision block 120B proceeds to step S35.

If steps S31 through S34 have not been completed for the display frame (No in step S35), then the period decision block 120B returns to step S31 to repeat steps S31 through S34 for the next pixel data (e.g., after processing of R0, processing of R1). On the other hand, if steps S31 through S34 have been completed for the display frame (Yes in step S35), the period decision block 120B proceeds to step S36.

The timing at which the depth information is detected by the detection block 110B is not especially restricted to a particular timing; for example, depth information may be regularly detected (e.g., depth information is read upon detection of a particular frame) or at any other state transition timing, such as a time at which an image to be reproduced by an imaging apparatus is switched (image feed or rewind), a reproduction start time, a reproduction stop time, a recording start time, a recording stop time, and a zooming time.

If the occurrence frequency is greater than the preset comparison value (Yes in step S36), then the period decision block 120B determines a period in accordance with the occurrence frequency. The display control block 130 controls the switching of L pixel and R pixel at the determined period, and the parallax barrier control block 140 controls the position change of the barrier 41 of the parallax barrier 40. Under the control of the display control block 130, the display apparatus 20 executes the switching of L pixel and R pixel. Under the control of the parallax barrier control block 140, the parallax barrier 40 executes the position change of the barrier 41 of the parallax barrier 40 (step S37). Then, the detection by the detection block 110B terminates.

On the other hand, if the occurrence frequency is below the preset frequency comparison value (No in step S36), then the period decision block 120B proceeds to step S41.

If it is determined that no depth information exists by the depth information decision block 150 (No in step S32), then the image conversion block 160 converts the image data into 3D image data (step S41). The depth information generated at this time is detected by the detection block 110B and outputted to the period decision block 120B as a detection result.

The period decision block 120B determines whether the depth value is greater than the preset depth comparison value. If the depth value is found to be greater than the depth comparison value, then the period decision block 120B counts the occurrence frequency (step S42). It should be noted that, every time step S42 is executed, count values are accumulated to compute the occurrence frequency. On the other hand, if the depth value is found to be below the depth comparison value, the period decision block 120B proceeds to step S44.

If steps S42 and S43 have not be completed for the display frame (No in step S44), then the period decision block 120B returns to step S42 to repeat steps S42 and S43 for the next pixel data (e.g., after processing of R0, processing of R1). On the other hand, if steps S42 and S43 have been completed for the display frame (Yes in step S44), then the period decision block 120B proceeds to step S45.

If the occurrence frequency is greater than the preset frequency comparison value (Yes in step S45), then the period decision block 120B determines a period in accordance with the occurrence frequency. The display control block 130 controls the switching of L pixel and R pixel at the determined period, and the parallax barrier control block 140 controls the position change of the barrier 41 and the parallax barrier 40. Under the control of the display control block 130, the display apparatus 20 executes the switching of L pixel and R pixel. Under the control of the parallax barrier control block 140, the parallax barrier 40 executes the position change of the barrier 41 of the parallax barrier 40 (step S47). Then, the detection by the detection block 110B terminates.

On the other hand, if the occurrence frequency is found to be below the preset frequency comparison value (No in step S45), then the period decision block 120B does not periodically execute the switching of L/R pixels and the position change of the barrier 41 of the parallax barrier 40 but continues the current state (step S46). Then, the detection by the detection block 110B terminates.

The flow of an operation of the display system according to the third embodiment of the disclosure has been described so far. As described above, the display system according to the third embodiment of the disclosure is provided with the same function as that of the display system according to the second embodiment of the disclosure, and supplies substantially the same effects as those of the display system according to the second embodiment of the disclosure. In addition, according to the third embodiment of the disclosure, when no depth information exists or when depth information exists but the parallax quantity is small, depth information can be obtained by converting image data into 3D image data.

### 3. Conclusion

As described so far, according to the first, second and third embodiments of the disclosure, if image data is 3D image data, chances of an unnecessary switching operation can be lowered as in the case where the image data is planar image data, thereby preventing increase of power consumption caused such switching. Consequently, the above-mentioned novel configuration provides the effect of efficiently mitigating burn-in. In addition, according to any one of the first through third embodiments of the disclosure, normal 3D display can be executed by controlling the switching of pixels and the position change of barriers of the parallax barrier together.

For the purpose of reference, a known technology for 3D image display will be described. For example, in one known technology associated with 3D image display that employs the parallax barrier method for 3D image display, the display positions of a left-eye image and a right-eye image are switched with a predetermined period while the position of the barrier 41 of the parallax barrier 40 is changed concurrently (refer to Japanese Patent Laid-open No. 2005-10303 for example).

However, depending on a parallax quantity, a 3D image has a deviation in display between a left-eye image and a right-eye image; if a parallax quantity is small, the image deviation between a left-eye image and a right-eye image is small, so that even if the positions of a left-eye image and a right-eye image are switched, the difference of data to be displayed on the same position is small. If the difference of data displayed on the same position is small, there would be no difference from the case where a same image is displayed on the same position. Occurrence of burn-in may not be prevented by the display position switching, resulting in unnecessary switching operations being repeated. In addition, since the switching is executed with a same period for any image, the power consumption due to switching tends to be increased.

The display control apparatus 10 according to any one of the first through third embodiments of the disclosure detects a difference between adjacent left-eye pixel data and right-eye pixel data and, based on a detection result, controls the switching of the adjacent left-eye pixel data and right-eye pixel data. In addition, based on the detection result, the display control apparatus 10 controls the changing of the barrier positions of parallax barriers. Consequently, according to the first through third embodiments of the disclosure, a significant effect of efficiently mitigating the burn-in is provided.

Further, the display system according to the third embodiment of the disclosure provides substantially the same effects as those of the display system according to the second embodiment of the disclosure. Still further, according to the third embodiment of the disclosure, if there is no depth information or if there is depth information but a parallax quantity is small, depth information can be obtained by converting image data into 3D image data.

While preferred embodiments of the present disclosure have been described referring to the accompanying drawings, the spirit and scope of the disclosure is not limited to those examples. It should be understood by those skilled in the art that various modifications, combinations, sub-combinations and alterations may occur depending on design requirements and other factors insofar as they are within the scope of the appended claims or the equivalents thereof.

For example, in the above description, examples where a display control apparatus 10 includes the function of detecting a difference between a plurality of pieces of pixel data forming image data and the function of determining a period corresponding to a result of the detection have been explained mainly. Alternatively, these functions may be provided by a server rather than the display control apparatus 10. For example, when the display control apparatus 10 transmits image data to a server, the server may detect a difference between the plurality of pieces of pixel data forming image data for the display control apparatus 10. Further, the server may determine a period for the display control apparatus 10. As such, the technology of this disclosure is also applicable to cloud computing, for example.

The processing steps in an operation of the display control apparatuses 10 herein do not need to be executed in the sequence shown in the flowcharts of the accompanying drawings. For example, the processing steps in an operation of the display control apparatuses 10 may be executed in a sequence different from those shown in the flowcharts, or may be executed in parallel.

In addition, a computer program may be created that enables hardware such as a CPU, ROM, and RAM incorporated in a display control apparatus 10 to provide the functions equivalent to those of the component blocks of the display control apparatus 10. Further, a recording media in which the computer program is stored is also provided.

It should be noted that the following configurations also belong to the technical scope of the present disclosure.

(1) A display control apparatus including: a detection block configured to detect a difference between a plurality of pixel data forming image data; and a display control block configured to control switching of the plurality of pixel data based on a detection result.

(2) The display control apparatus according to (1), wherein the image data is three-dimensional image data made up of a plurality of pieces of left-eye pixel data and a plurality of pieces of right-eye pixel data, the detection block detects a difference between adjacent left-eye pixel data and right-eye pixel data, the display control block controls switching of the adjacent left-eye pixel data and right-eye pixel data based on a detection result provided by the detection block, and the display control apparatus further includes a parallax barrier control block configured to control changing of a barrier position of a parallax barrier based on the detection result provided by the detection block.

(3) The display control apparatus according to (2), further including a period decision block configured to determine a period corresponding to the detection result provided by the detection block, wherein the display control block controls the switching of the adjacent left-eye pixel data and right-eye pixel data in accordance with the period determined by the period decision block, and the parallax barrier control block controls the changing of the barrier position of the parallax barrier in accordance with the period determined by the period decision block.

(4) The display control apparatus according to (3), wherein the detection block detects a difference in a luminance component between the adjacent left-eye pixel data and right-eye pixel data.

(5) The display control apparatus according to (4), wherein the period decision block determines the period in accordance with an occurrence frequency of a pair of adjacent left-eye pixel data and right-eye pixel data whose difference detected by the detection block exceeds a difference comparison value.

(6) The display control apparatus according to (5), wherein the period decision block weights a count value in accordance with a size of the difference detected by the detection block to compute the occurrence frequency based on a weighted count value.

(7) The display control apparatus according to (4), wherein the period decision block determines the period in accordance with a total value of the difference of each pair of the adjacent left-eye pixel data and right-eye pixel data detected by the detection block.

(8) The display control apparatus according to (2) or (3), wherein the detection block detects a depth value of one of the left-eye pixel data and the right-eye pixel data as the difference between the adjacent left-eye pixel data and right-eye pixel data.

(9) The display control apparatus according to (8), wherein the period decision block determines the period in accordance with an occurrence frequency of the one of left-eye pixel data and right-eye pixel data whose depth value detected by the detection block exceeds a depth comparison value.

(10) The display control apparatus according to (9), wherein the period decision block weights a count value in accordance with a size of the depth value detected by the detection block to compute the occurrence frequency based on a weighted count value.

(11) The display control apparatus according to (8), wherein the period decision block determines the period in accordance with a total value of depth values detected by the detection block.

(12) The display control apparatus according to (5) or (9), wherein the period decision block determines a shorter period the higher the occurrence frequency is.

(13) The display control apparatus according to (5) or (9), wherein, when the occurrence frequency falls below a frequency comparison value, the period decision block determines not to execute the switching control by the display control block and the changing control by the parallax barrier control block.

(14) The display control apparatus according to any of (8) to (11), furthering including: a depth information decision block configured to determine whether depth information exists; and an image conversion block configured to convert the image data into the three-dimensional image data when the depth information is determined not to exist by the depth information decision block.

(15) The display control apparatus according to (14), wherein, when the depth information is determined to exist by the depth information decision block, and an occurrence frequency of the one of left-eye pixel data and right-eye pixel data whose depth value exceeds the depth comparison value falls below a frequency comparison value, the image conversion block converts the image data into the three-dimensional image data.

(16) The display control apparatus according to any one of (1) to (15), wherein the detection block detects the difference for a partial area of image data of one frame.

(17) The display control apparatus according to any one of (1) to (16), wherein the detection block executes a next detection after elapse of a time corresponding to a current detection result.

(18) The display control apparatus according to any one of (1) to (16), wherein the detection block detects the difference at a time interval corresponding to a continuous display time of the image data.

(19) A display control method including: detecting a difference between a plurality of pixel data forming image data; and controlling switching of the plurality of pixel data based on a detection result.

(20) A program allowing a computer to function as a display control apparatus including: a detection block configured to detect a difference between a plurality of pixel data forming image data; and a display control block configured to control switching of the plurality of pixel data based on a detection result.

The present disclosure contains subject matter related to that disclosed in Japanese Priority Patent Application JP 2011-193027 filed in the Japan Patent Office on Sep. 5, 2011, the entire content of which is hereby incorporated by reference.

What is claimed is:

1. A display control apparatus comprising:
a detection block configured to detect a difference between a plurality of pixel data forming image data; and
a display control block configured to control switching of said plurality of pixel data based on a detection result.

2. The display control apparatus according to claim 1, wherein
said image data is three-dimensional image data made up of a plurality of pieces of left-eye pixel data and a plurality of pieces of right-eye pixel data,
said detection block detects a difference between adjacent left-eye pixel data and right-eye pixel data,
said display control block controls switching of said adjacent left-eye pixel data and right-eye pixel data based on a detection result provided by said detection block, and
said display control apparatus further includes a parallax barrier control block configured to control changing of a barrier position of a parallax barrier based on the detection result provided by said detection block.

3. The display control apparatus according to claim 2, further comprising
a period decision block configured to determine a period corresponding to the detection result provided by said detection block,
wherein
said display control block controls the switching of said adjacent left-eye pixel data and right-eye pixel data in accordance with the period determined by said period decision block, and
said parallax barrier control block controls the changing of the barrier position of said parallax barrier in accordance with the period determined by said period decision block.

4. The display control apparatus according to claim 3, wherein
said detection block detects a difference in a luminance component between said adjacent left-eye pixel data and right-eye pixel data.

5. The display control apparatus according to claim 4, wherein
said period decision block determines said period in accordance with an occurrence frequency of a pair of adjacent left-eye pixel data and right-eye pixel data whose difference detected by said detection block exceeds a difference comparison value.

6. The display control apparatus according to claim 5, wherein
said period decision block weights a count value in accordance with a size of the difference detected by said detection block to compute said occurrence frequency based on a weighted count value.

7. The display control apparatus according to claim 4, wherein
said period decision block determines said period in accordance with a total value of the difference of each pair of said adjacent left-eye pixel data and right-eye pixel data detected by said detection block.

8. The display control apparatus according to claim 2, wherein
said detection block detects a depth value of one of said left-eye pixel data and said right-eye pixel data as the difference between said adjacent left-eye pixel data and right-eye pixel data.

9. The display control apparatus according to claim 8, wherein
said period decision block determines said period in accordance with an occurrence frequency of said one of left-eye pixel data and right-eye pixel data whose depth value detected by said detection block exceeds a depth comparison value.

10. The display control apparatus according to claim 9, wherein
said period decision block weights a count value in accordance with a size of the depth value detected by said detection block to compute said occurrence frequency based on a weighted count value.

11. The display control apparatus according to claim 8, wherein
said period decision block determines said period in accordance with a total value of depth values detected by said detection block.

12. The display control apparatus according to claim 5, wherein
said period decision block determines a shorter period the higher said occurrence frequency is.

13. The display control apparatus according to claim 5, wherein,
when said occurrence frequency falls below a frequency comparison value, said period decision block determines not to execute the switching control by said display control block and the changing control by said parallax barrier control block.

14. The display control apparatus according to claim 8, further comprising:
a depth information decision block configured to determine whether depth information exists; and
an image conversion block configured to convert said image data into said three-dimensional image data when said depth information is determined not to exist by said depth information decision block.

15. The display control apparatus according to claim 14, wherein,
when said depth information is determined to exist by said depth information decision block, and an occurrence frequency of said one of left-eye pixel data and right-eye pixel data whose depth value exceeds said depth comparison value falls below a frequency comparison value, said image conversion block converts said image data into said three-dimensional image data.

16. The display control apparatus according to claim 1, wherein
said detection block detects said difference for a partial area of image data of one frame.

17. The display control apparatus according to claim 1, wherein
said detection block executes a next detection after elapse of a time corresponding to a current detection result.

18. The display control apparatus according to claim 1, wherein
said detection block detects said difference at a time interval corresponding to a continuous display time of said image data.

19. A display control method comprising:
detecting a difference between a plurality of pixel data forming image data; and
controlling switching of said plurality of pixel data based on a detection result.

20. A program allowing a computer to function as a display control apparatus comprising:
a detection block configured to detect a difference between a plurality of pixel data forming image data; and
a display control block configured to control switching of said plurality of pixel data based on a detection result.
